(19) United States
(12) Patent Application Publication
(10) Pub. No.: US 2026/0230314 A1
(43) Pub. Date: Aug. 6, 2026

(54) KEY MANAGEMENT APPARATUS, KEY MANAGEMENT METHOD, AND DATA STORING SYSTEM

(71) Applicant: NEC Corporation, Tokyo (JP)

(72) Inventor: Takao OCHI, Tokyo (JP)

(73) Assignee: NEC Corporation, Tokyo (JP)

(21) Appl. No.: 19/453,121

(22) Filed: Jan. 20, 2026

(30) Foreign Application Priority Data
Feb. 4, 2025 (JP) 2025-016715

(51) Int. Cl. H04L 9/08

(52) U.S. Cl. CPC H04L 9/0852; H04L 9/0822

(57) ABSTRACT

A key management apparatus includes a determination unit that determines a predetermined number of participants among a plurality of participants for storing divided data obtained by division from predetermined data by secret distribution processing, as participants for encrypting and storing the divided data by using a quantum encryption key, and a key transmission unit that transmits an encryption key used to encrypt the divided data to each of the predetermined number of participants by quantum key distribution. The determination unit determines the predetermined number of participants based on a number of hops of a key relay from the key management apparatus to each participant in the quantum key distribution.

### INCORPORATION BY REFERENCE

This application is based upon and claims the benefit of priority from Japanese patent application No. 2025-016715, filed on February 4, 2025, the disclosure of which is incorporated herein in its entirety by reference.

### TECHNICAL FIELD

The present disclosure relates to a key management apparatus, a key management method, a data storing system, and a program.

### BACKGROUND ART

A secret sharing method (m-of-n method) is used to protect data that is secret information from information leakage and the risk of loss. In the secret sharing method, a user transmits data intended to be protected by the secret sharing method to a dealer. The dealer divides the data into a plurality of pieces of divided data and transmits the plurality of pieces of divided data to a plurality of participants. Each participant stores the divided data. The divided data is called share, and the participants are also called share folders. In the m-of-n method, by setting the total number of shares as n (n is an integer that is equal to or more than 3), and using m (m is an integer that is equal to or more than 2 and less than n) shares among the n shares, the original data can be restored.

Quantum cryptographic communication has attracted attention as a system for encrypting data and performing communication of the data. In quantum cryptographic communication, an encryption key is shared between a transmission device and a reception device in advance, by using a quantum key distribution (QKD) device. In a communication path between the transmission device and the reception device, data is encrypted with one time pad (OTP) by using a shared encryption key (common key). In the secret sharing method, the transmission device of the dealer and each of the reception device of the total n participants share a common key different for each participant by using the quantum key distribution device. The transmission device of the dealer encrypts the divided data with the one time pad encryption by using the common key with the participant, and transmits the encrypted data to the participant. The reception device of the participant receives the encrypted data, and decrypts the received encrypted data with the one time pad by using the common key. Data storage using the secret sharing method is described in, for example, JP 2024-142378 A.

### SUMMARY

In the secret sharing method, even if one share is intercepted by a third party, it is impossible to restore original data from the one intercepted share. Each share is meaningless data by itself, and it is also impossible to forcibly decrypt the original data from one share. However, in a case where m or more shares are intercepted by the third party in a certain method, the third party can restore the original data from the m or more shares.

In order to prevent restoration to original data even in a case where m or more shares are intercepted, it is conceivable to, upon the share is stored, encrypt each share by using one time pad encryption that secures information theoretical security and store the encrypted share. The security of data is secured in a manner that the share encrypted by using the one time pad encryption is stored in each share folder.

However, in a case where divided data is encrypted by using a quantum encryption key by a participant, it is necessary to securely transmit an encryption key to each of a plurality of participants via a QKD apparatus. In a case where all pieces of divided data are encrypted and stored in a share folder in the secret sharing method, there is a problem that a large amount of encryption keys are consumed in a quantum key distribution network (QKDN) in order to protect one piece of secret information. This is because, regarding the encryption key shared by quantum key distribution, the number of divisions is consumed by the one time pad upon each piece of divided data of one piece of secret information is encrypted or decrypted.

An example object of the present disclosure is to provide a key management apparatus, a key management method, a data storing system, and a program capable of suppressing consumption of an encryption key in quantum key distribution while ensuring the security of secret information in accordance with a secret sharing method.

A key management apparatus according to a first example aspect of the present disclosure includes a determination unit that determines a predetermined number of participants among a plurality of participants for storing divided data obtained by division from predetermined data by secret distribution processing, as participants for encrypting and storing the divided data by using a quantum encryption key, and a key transmission unit that transmits an encryption key used to encrypt the divided data to each of the predetermined number of participants by quantum key distribution. The determination unit determines the predetermined number of participants based on the number of hops of a key relay from the key management apparatus to each participant in the quantum key distribution. In a case where the predetermined number is set as p, the number of divisions of the predetermined data is set as N, and the minimum number of pieces of the divided data in a case where the predetermined data is restored from the pieces of the divided data is set as m, the predetermined number p satisfies N-m+1 ≤ p < N.

A data storing system according to a second example aspect of the present disclosure includes a transaction apparatus including a division unit that divides predetermined data into a plurality of pieces of divided data by secret distribution processing, and a data transmission unit that transmits the plurality of pieces of divided data to a plurality of participant apparatuses, a participant apparatus that receives the divided data and includes an encryption unit that encrypts the received divided data by using a quantum encryption key and a data storing unit that stores the encrypted divided data, and the key management apparatus. The key management apparatus includes a determination unit that determines a predetermined number of participant apparatuses among the plurality of participant apparatuses, as participant apparatuses that encrypt and store the divided data, and a key transmission unit that transmits an encryption key used to encrypt the divided data to each of the predetermined number of participant apparatuses by quantum key distribution. The determination unit determines the predetermined number of participants based on the number of hops of a key relay from the key management apparatus to each participant in the quantum key distribution. In a case where the predetermined number is set as p, the number of divisions of the predetermined data is set as N, and the minimum number of pieces of the divided data in a case where the predetermined data is restored from the pieces of the divided data is set as m, the predetermined number p satisfies N-m+1 ≤ p < N.

A key management method according to a third example aspect of the present disclosure includes determining a predetermined number of participants among a plurality of participants for storing divided data obtained by division from predetermined data by secret distribution processing, as participants for encrypting and storing the divided data by using a quantum encryption key, and transmitting an encryption key used to encrypt the divided data to each of the predetermined number of participants by quantum key distribution, in which, the determining of the predetermined number of participants includes determining the predetermined number of participants based on a number of hops of a key relay from a key management apparatus to each participant in the quantum key distribution, and, in a case where the predetermined number is set as p, a number of divisions of the predetermined data is set as N, and a minimum number of pieces of the divided data in a case where the predetermined data is restored from the pieces of the divided data is set as m, N-m+1 ≤ p < N is satisfied.

A program according to a fourth example aspect of the present disclosure causes a computer to execute processing including determining a predetermined number of participants among a plurality of participants for storing divided data obtained by division from predetermined data by secret distribution processing, as participants for encrypting and storing the divided data by using a quantum encryption key, and transmitting an encryption key used to encrypt the divided data to each of the predetermined number of participants by quantum key distribution, in which, the determining of the predetermined number of participants includes determining the predetermined number of participants based on a number of hops of a key relay from a key management apparatus to each participant in the quantum key distribution, and, in a case where the predetermined number is set as p, a number of divisions of the predetermined data is set as N, and a minimum number of pieces of the divided data in a case where the predetermined data is restored from the pieces of the divided data is set as m, N-m+1 ≤ p < N is satisfied.

The key management apparatus, the key management method, the data storing system, and the program according to the present disclosure can suppress the consumption of an encryption key in quantum key distribution while securing the security of secret information by a secret sharing method.

### BRIEF DESCRIPTION OF THE DRAWINGS

The above and other aspects, features and advantages of the present disclosure will become more apparent from the following description of certain example embodiments when taken in conjunction with the accompanying drawings, in which:

FIG. 1 is a block diagram illustrating a schematic configuration example of a data storing system according to the present disclosure;

FIG. 2 is a block diagram illustrating an example of an overall configuration of the data storing system;

FIG. 3 is a block diagram illustrating a configuration example of a transaction apparatus and a distributed management apparatus;

FIG. 4 is a block diagram illustrating a configuration example of a user apparatus;

FIG. 5 is a block diagram illustrating a configuration example of a key management apparatus;

FIG. 6 is a diagram illustrating an example of a QKD network;

FIG. 7 is a diagram illustrating an example of a delivery route candidate list;

FIG. 8 is a diagram illustrating an example of an optimal delivery route list;

FIG. 9 is a diagram illustrating an example of determining a share folder being an encryption target;

FIG. 10 is a diagram illustrating an example of data management information;

FIG. 11 is a flowchart illustrating an operation procedure of the data storing system at the time of storing data;

FIG. 12 is a flowchart illustrating an operation procedure of the data storing system at the time of restoring data; and

FIG. 13 is a block diagram illustrating a configuration example of a computer apparatus.

### EXAMPLE EMBODIMENT

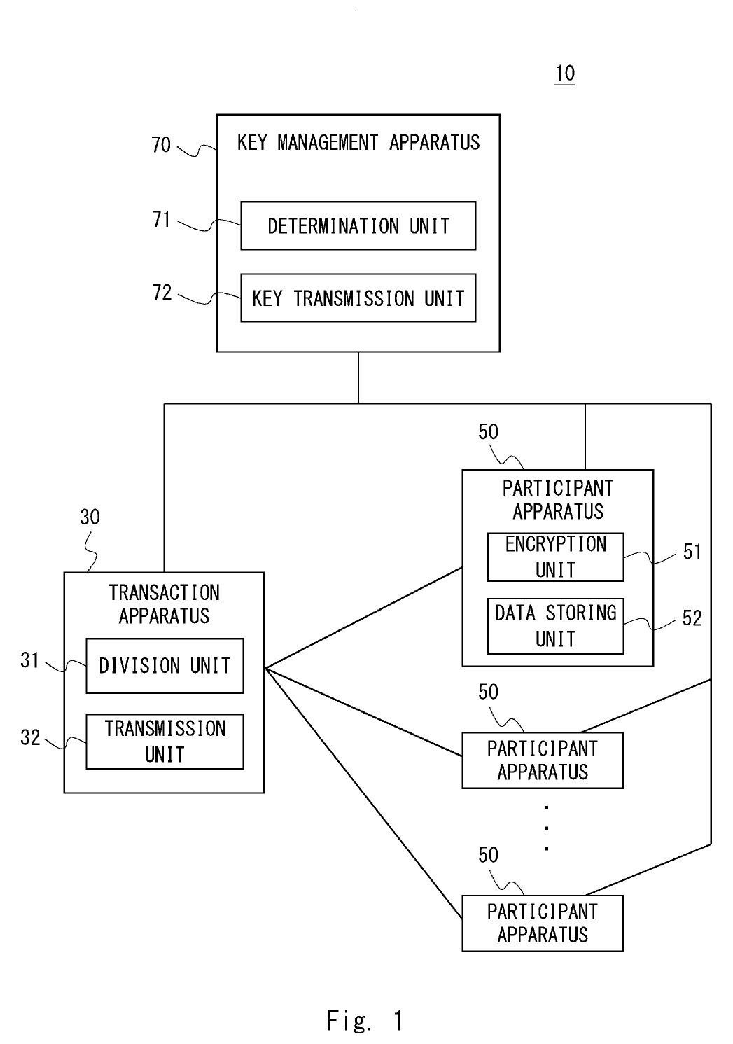

Prior to describing example embodiments of the present disclosure, outline of the present disclosure will be described. FIG. 1 is a block diagram illustrating a schematic configuration example of a data storing system according to the present disclosure. A data storing system 10 illustrated in FIG. 1 includes a transaction apparatus 30, a plurality of participant apparatuses 50, and a key management apparatus 70. In the present disclosure, predetermined data that is secret information is divided into a plurality of pieces of divided data for a plurality of participants by the secret sharing method (m-of-n method).

The transaction apparatus 30 is an apparatus used by a dealer in the secret sharing method. The transaction apparatus 30 includes a division unit 31 and a transmission unit 32. The division unit 31 divides predetermined data into a plurality of pieces of divided data by secret distribution processing. The transmission unit 32 transmits the plurality of divided data obtained by the division to a plurality of participant apparatuses 50.

Each of the plurality of participant apparatuses 50 is an apparatus used by a participant in the secret sharing method. Each participant apparatus 50 includes an encryption unit 51 and a data storing unit 52. The encryption unit 51 receives the divided data from the transaction apparatus 30 and encrypts the received divided data by using a quantum encryption key. The data storing unit 52 stores the encrypted divided data.

In the present disclosure, the divided data is encrypted and stored in a predetermined number of participant apparatuses 50 among the plurality of participant apparatuses 50. The key management apparatus 70 performs determination of the participant apparatus 50 to perform encryption and transmission of an encryption key.

The key management apparatus 70 includes a determination unit 71 and a key transmission unit 72. The determination unit 71 determines a predetermined number of participant apparatuses 50 among the plurality of participant apparatuses 50, as participant apparatuses 50 that encrypt and store the divided data. The key transmission unit 72 transmits an encryption key used to encrypt the divided data to each of the predetermined number of participant apparatuses 50 by quantum key distribution.

The determination unit 71 determines the predetermined number of participants based on the number of hops of a key relay from the key management apparatus to each participant in the quantum key distribution. In a case where a predetermined number is set as p, the number of divisions of predetermined data is set as N, and the minimum number of pieces of divided data in a case where the predetermined data is restored from the pieces of divided data is set as m, the predetermined number p satisfies N-m+1 ≤ p < N.

In the present disclosure, the predetermined number of participant apparatuses 50 receive the encryption keys used to encrypt the divided data from the key management apparatus 70, and the remaining participant apparatuses 50 do not receive the encryption key used to encrypt the divided data from the key management apparatus 70. In the participant apparatus 50 that has received the encryption key, the encryption unit 51 encrypts the divided data by using the received encryption key. In the participant apparatus 50 that has not received the encryption key, the encryption unit 51 does not encrypt the divided data, and the divided data that is not encrypted is stored in the data storing unit 52.

In the present disclosure, data is divided into a plurality of pieces of divided data by the secret sharing method such as the m-of-n method, and the plurality of pieces of divided data are stored by a plurality of participants. By participants of which the number is less than N and is equal to or more than (N-m+1) among the total number N of participants, the divided data is encrypted, and the encrypted divided data is stored. In this case, the number of divided data that is not encrypted among pieces of divided data stored by the plurality of participants is less than m. Therefore, even in a case where m or more participants (share folders) are attacked and divided data is intercepted, it is possible to avoid information leakage. In the present disclosure, by combining the secret sharing method and encryption, it is possible to reduce the risk of data leakage as compared with the case of storing data divided only by the secret sharing method.

Generally, in order to prevent the loss of secret information even in a case where a large-scale disaster has occurred, secret information, that is, each piece of divided data, is stored in a remote share folder, that is, the participant apparatus 50. In a case where divided data is encrypted and stored in all share folders, it is necessary to distribute a quantum encryption key used for encryption to all of a large number of participant apparatuses 50 located far away. Usually, in a quantum key distribution network, it is not possible that a QKD apparatus alone that shares an encryption key transmits the encryption key over a long distance. In order to share an encryption key between two geographically separated bases, it is necessary to perform key relay in a quantum key distribution network. In the key relay, the encryption key of the QKDN is consumed as the number of hops increases. If all shares are encrypted and stored by quantum encryption, there is a problem that a large amount of encryption keys in the QKDN are consumed due to the key relay.

In the present disclosure, in a case where the number of divisions of data is N, and original data can be restored from m or more pieces of divided data among N pieces of divided data, the divided data is encrypted in the predetermined number p of participant apparatuses 50 smaller than the total number N of pieces of the divided data. In this case, it is possible to suppress consumption of the encryption key used to encrypt data, as compared with a case where all pieces of divided data are encrypted. In the present disclosure, the determination unit 71 determines the predetermined number of participants based on the number of hops of a key relay from the key management apparatus to each participant in the quantum key distribution. By preferentially determining a participant with a small number of hops as the predetermined number of participants, based on the number of hops of the key relay, it is possible to suppress the number of encryption keys consumed by the key relay in a case where the encryption key is delivered to the participant. Therefore, the data storing system 10 according to the present disclosure can suppress the consumption of an encryption key in quantum key distribution while securing the security of secret information by a secret sharing method.

Hereinafter, an example embodiments of the present disclosure will be described in detail with reference to the drawings. In the drawings, the same or relevant elements are denoted by the same reference numerals, and repeated description will be omitted as necessary for clarity of description.

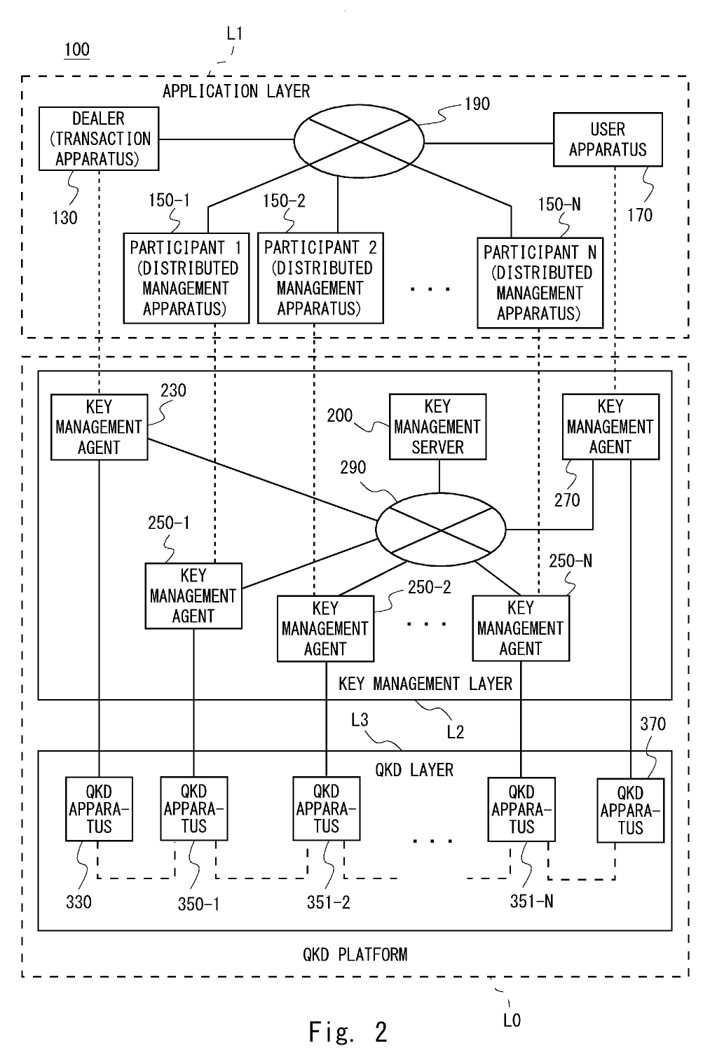

FIG. 2 is a block diagram illustrating an example of an overall configuration of a data storing system 100. An example embodiment of the present disclosure will be described with reference to FIG. 2. The data storing system 100 includes an application layer L1, a key management layer L2, and a QKD layer L3. The key management layer L2 and the QKD layer L3 are included in a QKD platform L0.

In an example embodiment, the data storing system 100 is used for an application in which a dealer divides user data into a plurality of pieces of divided data and stores the plurality of pieces of divided data in a distributed manner to a plurality of participants. The plurality of participants indicate entities that participate in storage of divided data (also referred to as share) in secret distribution processing. A user using data acquires the divided data from the plurality of participants and restores original data. The data storing system 100 is relevant to the data storing system 10 illustrated in FIG. 1.

The application layer L1 includes a transaction apparatus 130 on the dealer side, distributed management apparatuses 150-1 to 150-N relevant to a plurality of participants 1 to N (N is an integer that is equal to or more than 3), and a user apparatus 170 on the user side using data. In the application layer L1, the transaction apparatus 130, the distributed management apparatuses 150-1 to 150-N, and the user apparatus 170 are communicably connected via an application network 190. The application network 190 includes a wired communication network, a wireless communication network, or a combination of these. The application network 190 includes, for example, the Internet or a line network of a dedicated line. In the application network 190, communication of user data and divided data is encrypted by using quantum cryptography.

The transaction apparatus 130 is an information processing apparatus or an information processing system used to disperse and store data using the secret sharing method. The user apparatus 170 is an information processing device or an information processing system used by a user using stored data. The transaction apparatus 130 is relevant to the transaction apparatus 30 illustrated in FIG. 1.

Each of the distributed management apparatuses 150-1 to 150-N is an information processing apparatus or an information processing system used by a participant. The distributed management apparatuses 150-1 to 150-N are also referred to as distributed management apparatuses 150 in a case where distinction is not particularly necessary. The distributed management apparatus 150 is relevant to the participant apparatus 50 illustrated in FIG. 1. In an example embodiment, it is assumed that the transaction apparatus 130, the distributed management apparatus 150, and the user apparatus 170 are installed in physically separated bases.

The key management layer L2 includes a key management server 200, a key management agent 230, key management agents 250-1 to 250-N, and a key management agent 270. The key management server 200, the key management agent 230, the key management agents 250-1 to 250-N, and the key management agent 270 are communicably connected via a key management network 290. The key management network 290 includes a wired communication network, a wireless communication network, or a combination of these. The application network 190 includes, for example, the Internet or a line network of a dedicated line.

The key management server 200 is a computer apparatus that manages an encryption key used for quantum cryptographic communication. The key management server 200 performs management of quantum key distribution and key relay, and management of an accumulation amount of unused encryption keys generated in the QKD layer L3. The key management server 200 performs a process of selecting a share being an encryption target among N shares in the application layer L1. The key management server 200 is relevant to the key management apparatus 70 illustrated in FIG. 1.

The key management agent 230, the key management agents 250-1 to 250-N, and the key management agent 270 are each configured as an information processing apparatus or an information processing system. The key management agent 230, the key management agents 250-1 to 250-N, and the key management agent 270 are communicably connected to the transaction apparatus 130, the distributed management apparatuses 150-1 to 150-N, and the user apparatus 170, respectively. The key management agents 250-1 to 250-N are also referred to as key management agents 250 in a case where there is no particular need to distinguish.

The key management agent 230 is a key management agent relevant to the transaction apparatus 130, and the key management agent 270 is a key management agent relevant to the user apparatus 170. The key management agents 250-1 to 250-N are key management agents relevant to the distributed management apparatuses 150-1 to 150-N, respectively. The key management agents 250-1 to 250-N are installed, for example, in physically separated bases. The key management agent 230, the key management agent 250, and the key management agent 270 may be configured as independent devices, or may be software modules that operate in relevant apparatuses of the application layer L1.

The key management agent 230, the key management agent 250, and the key management agent 270 accumulate an encryption key that is generated in the QKD layer L3 and is quantum-key-distributed. The key management agent 230, the key management agent 250, and the key management agent 270 each supply a quantum encryption key used to encrypt a share to the application layer L1. The key management agent 230, the key management agents 250-1 to 250-N, and the key management agent 270 also perform a process of supplying an encryption key for encrypted communication of divided data to the application layer L1.

The QKD layer L3 includes a QKD apparatus 330, QKD apparatuses 350-1 to 350-N, and a QKD apparatus 370. The QKD apparatus 330, the QKD apparatuses 350-1 to 350-N, and the QKD apparatus 370 are communicably connected to the key management agent 230, the key management agents 250-1 to 250-N, and the key management agent 270 of the key management layer L2, respectively. The QKD apparatuses 350-1 to 350-N are also referred to as QKD apparatuses 350 in a case where distinction is not particularly necessary. The QKD apparatus 330, the QKD apparatuses 350-1 to 350-N, and the QKD apparatus 370 are configured as, for example, hardware modules. The QKD apparatus 330, the QKD apparatus 350, and the QKD apparatus 370 are not limited to hardware modules. The function of the QKD apparatus may be implemented by a software module and a hardware module operating in cooperation with each other.

Each of the QKD apparatus 330, the QKD apparatus 350, and the QKD apparatus 370 generates an intrinsic random number having a predetermined length as an encryption key, and supplies the generated encryption key to the key management agent 230, the key management agent 250, and the key management agent 270 to be connected. In the QKD layer L3, two adjacent or facing QKD apparatuses are connected by a dedicated optical fiber. It is assumed that the facing QKD apparatuses have a distance in which a transmission loss of the optical fiber is allowable. The QKD apparatus transmits, to the facing QKD apparatus, an encryption key shared between the key management agents relevant to the respective QKD apparatuses, that is, a common key through quantum cryptographic communication via an optical fiber.

In a case where the encryption key is transmitted based on quantum key distribution, and a distance of transmission sections is equal to or greater than a certain distance, there is a case where it is not possible to transmit the encryption key only by the quantum key distribution due to a physical constraint. Therefore, key relay is used to share an encryption key based on quantum key distribution between a pair of communication apparatuses in a transmission section of a certain distance or more. The key relay is a technology of relaying one or more communication apparatuses between both ends of a transmission section and transmitting an encryption key to be shared by encrypted communication. The communication apparatus used to relay the encryption key is also referred to as a relay apparatus or a site. The relay apparatus or site is referred to as a trusted node. In the key relay, in transmission of the encryption key itself between one end of a transmission section and the relay apparatus or between the relay apparatuses, the encryption key is transmitted by encrypted communication using the one time pad with the encryption key that is shared in advance between the apparatuses based on quantum key distribution. Therefore, in the key relay, an encryption key shared based on quantum key distribution is consumed.

FIG. 2 illustrates an example in which one key management agent is connected to one QKD apparatus, but the present example embodiment is not limited to this. One key management agent may be connected to two or more QKD apparatuses.

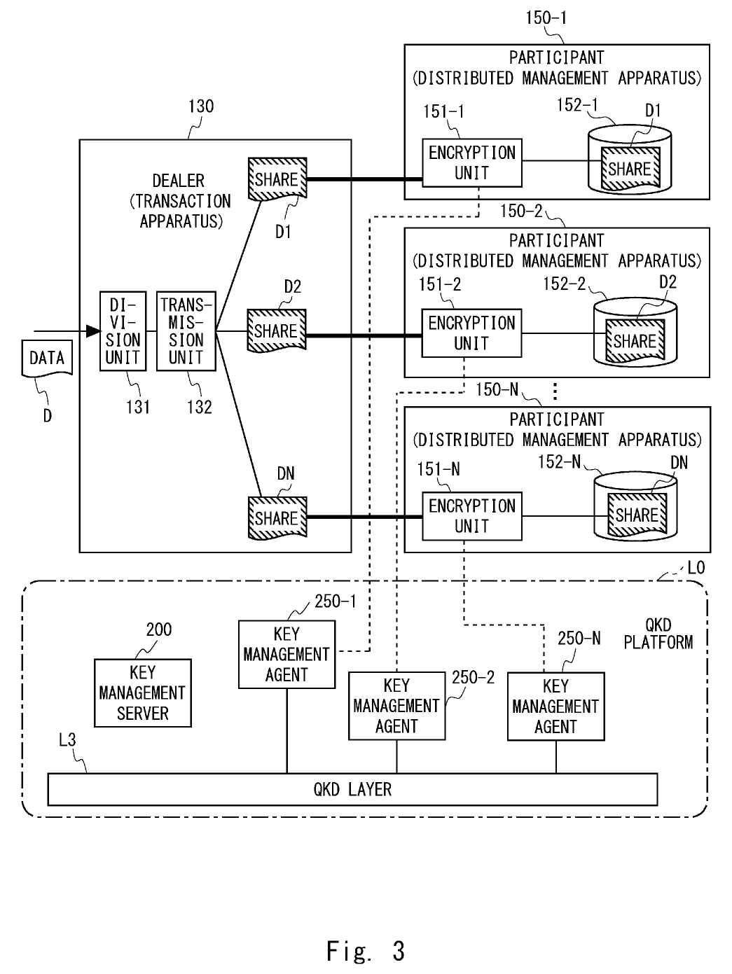

FIG. 3 is a block diagram illustrating configuration examples of the transaction apparatus 130 and the distributed management apparatuses 150-1 to 150-N. The transaction apparatus 130 includes a division unit 131 and a transmission unit 132. The transaction apparatus 130 may be physically configured as a computer apparatus having, for example, one or more memories and one or more processors. At least some of the functions of the units in the transaction apparatus 130 can be implemented by the processor executing processing according to a command read from the memory.

The division unit 131 receives data D from a user via the application network 190, for example. The data D may be encrypted by using quantum cryptography in the application network 190. The division unit 131 divides the data D into N shares D1 to DN by secret distribution processing.

In an example embodiment, the division unit 131 divides the data D into the shares D1 to DN by using data division processing using the threshold-type secret sharing method. More specifically, in a case where a natural number smaller than the number of divisions N is set as m, the division unit 131 uses m as a threshold value, and divides the data D such that original data D can be restored from m or more shares among the shares D1 to DN, and it is not possible to decrypt the original data D from each share.

The transmission unit 132 transmits the divided N shares D1 to DN to the distributed management apparatuses 150-1 to 150-N relevant to the participants 1 to N via the application network 190. The shares D1 to DN may be encrypted by using quantum cryptography in the application network 190.

The distributed management apparatuses 150-1 to 150-N include encryption units 151-1 to 151-N and data storing units 152-1 to 152-N, respectively. Each distributed management apparatus 150 may be physically configured as a computer apparatus having, for example, one or more memories and one or more processors. At least some of the functions of the units in the distributed management apparatus 150 can be implemented by the processor executing processing in accordance with a command read from the memory.

The encryption units 151-1 to 151-N encrypt the shares D1 to DN received from the transaction apparatus 130, respectively. The data storing units 152-1 to 152-N store the encrypted shares D1 to DN in a storage device. The encryption units 151-1 to 151-N are also referred to as encryption units 151 in a case where distinction is not particularly necessary. The data storing units 152-1 to 152-N are also referred to as data storing units 152 in a case where distinction is not particularly necessary.

In an example embodiment, a predetermined number or more of shares among the N shares D1 to DN stored in the data storing unit 152 are encrypted and stored in the distributed management apparatus 150. Specifically, in a case where original data can be restored by using m shares among the N shares, shares of which the number is equal to or more than (N-m+1) and less than N among the N shares D1 to DN are encrypted.

In the QKD platform L0, the key management server 200 determines which distributed management apparatus 150 among a plurality of distributed management apparatuses 150 is to perform encryption. The key management server 200 transmits a quantum encryption key used for encryption to the distributed management apparatus 150 to which encryption is performed through the key management agent 230. The quantum encryption key is transmitted from the key management server 200 to the distributed management apparatus 150 by key relay via some QKD apparatuses in the QKD layer L3. In the distributed management apparatus 150 that has received the quantum encryption key, the encryption unit 151 encrypts the share with the one time pad by using the quantum encryption key. In a case where the quantum encryption key is not received, the distributed management apparatus 150 stores the share without encrypting the share.

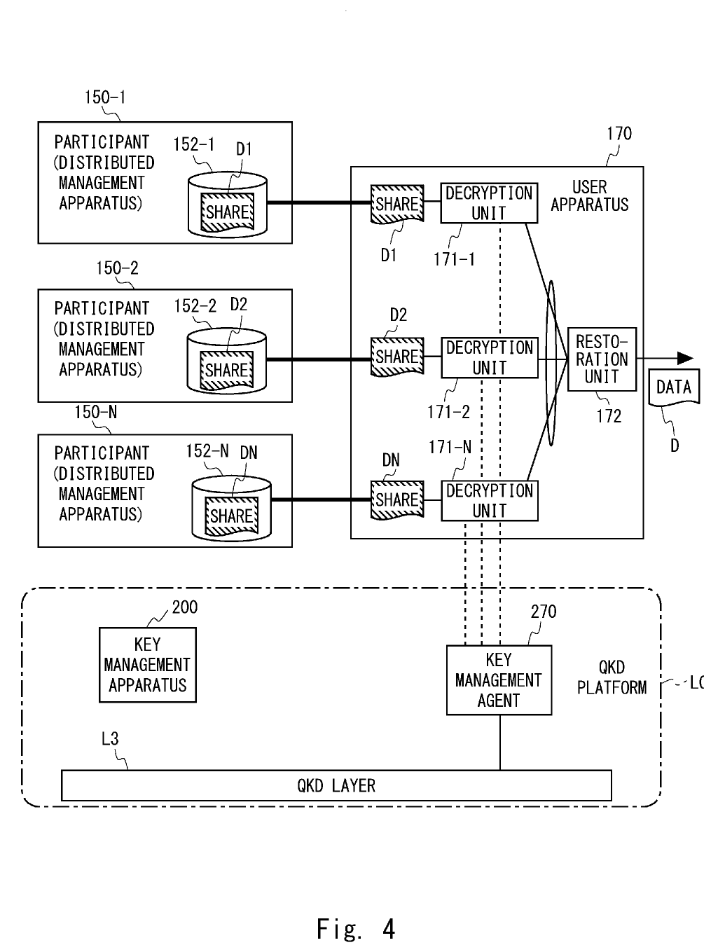

FIG. 4 is a block diagram illustrating a configuration example of the user apparatus 170. The user apparatus 170 includes decryption units 171-1 to 171-N and a restoration unit 172. The user apparatus 170 may be physically configured as a computer apparatus having, for example, one or more memories and one or more processors. At least some of the functions of the units in the user apparatus 170 can be implemented by the processor executing processing according to a command read from the memory.

In the QKD platform L0, the key management server 200 transmits the quantum encryption key used for encryption in the distributed management apparatus 150 to the user apparatus 170 through the key management agent 270. The quantum encryption key is transmitted from the key management server 200 to the user apparatus 170 by key relay via some QKD apparatuses in the QKD layer L3. In the user apparatus 170, the decryption units 171-1 to 171-N receive the quantum encryption key transmitted from the key management server 200.

The decryption units 171-1 to 171-N acquire the shares D1 to DN from the distributed management apparatuses 150-1 to 150-N, respectively. The decryption units 171-1 to 171-N decrypt the share that is encrypted and stored in the data storing unit 152, by using the received quantum encryption key. The decryption units 171-1 to 171-N decrypt the share with the one time pad by using, for example, the quantum encryption key. The decryption units 171-1 to 171-N are also referred to as decryption units 171 in a case where distinction is not particularly necessary. In a case where the share acquired from the distributed management apparatus 150 is not encrypted, the decryption unit 171 does not perform decryption.

The decryption unit 171 outputs the share that is not encrypted to the restoration unit 172. The restoration unit 172 restores original data D by using the share output from the decryption unit 171. The data D can be restored from m shares among the shares D1 to DN. Therefore, the decryption unit 171 does not necessarily need to acquire all of the N shares.

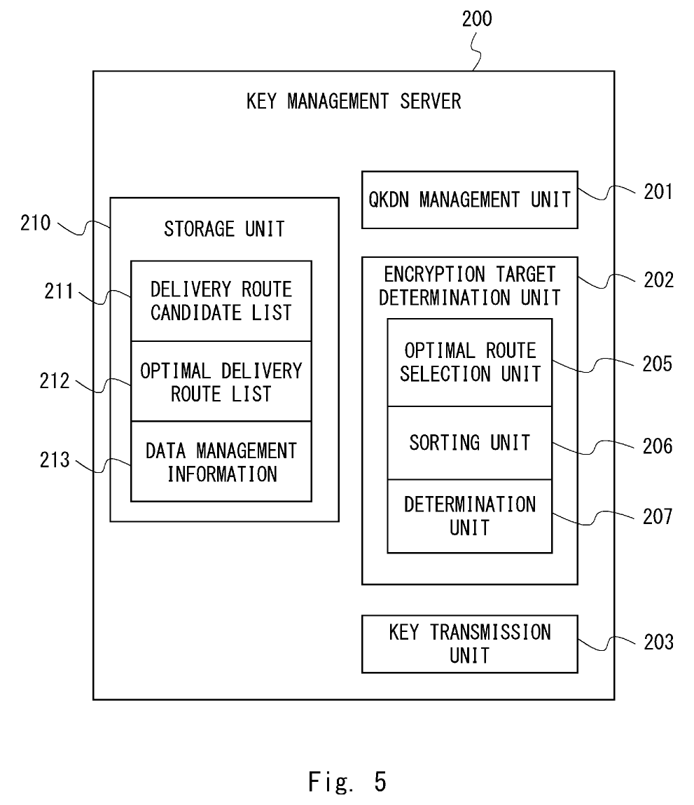

FIG. 5 is a block diagram illustrating a configuration example of the key management server 200. The key management server 200 includes a QKDN management unit 201, an encryption target determination unit 202, a key transmission unit 203, and a storage unit 210. The storage unit 210 includes, for example, a nonvolatile storage device such as a flash memory and a volatile storage device such as a random access memory (RAM). The storage unit 210 stores a delivery route candidate list 211, an optimal delivery route list 212, and data management information 213.

Each key management server 200 may be physically configured as a computer apparatus having, for example, one or more memories and one or more processors. At least some of the functions of the units in the key management server 200 can be implemented by the processor executing processing in accordance with a command read from the memory. Although not illustrated in FIG. 5, the key management server 200 includes an interface circuit that communicates with the key management server 200 and the outside. The key management server 200 can be configured to be able to communicate with the transaction apparatus 130 and the user apparatus 170 via the application network 190 through the interface circuit.

The QKDN management unit 201 manages the QKD platform L0. For example, the QKDN management unit 201 manages the accumulation amount of the encryption key in the key management layer L2. The QKDN management unit 201 generates candidates for a delivery route in the key relay for each transmission section. In particular, the QKDN management unit 201 generates a candidate for the delivery route in the key relay of the quantum encryption key used to encrypt the share stored in the distributed management apparatus 150. The QKDN management unit 201 generates candidates for a route that can be used for distribution of the quantum encryption key between the key management server 200 and the distributed management apparatus 150 for each share folder, that is, for each participant. Further, the QKDN management unit 201 determines the priority order for each path candidate based on the accumulation amount of the encryption key, the number of hops of the key relay, the communication status of a key relay path, and the like.

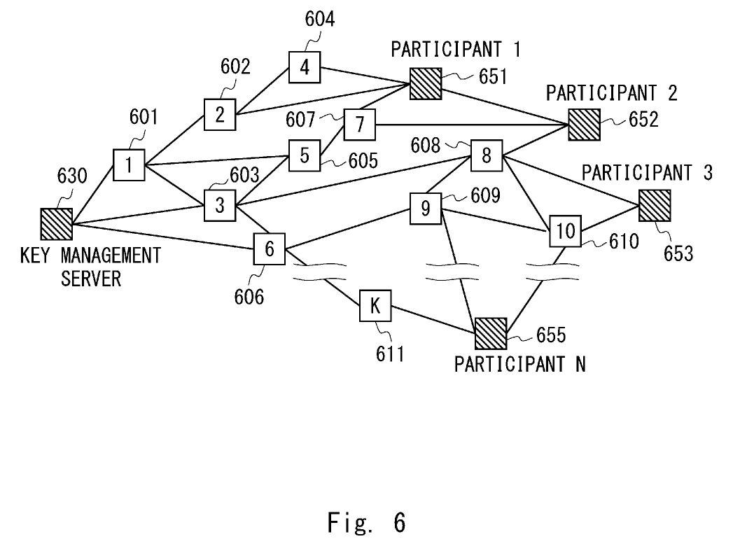

FIG. 6 is a diagram illustrating an example of the QKD network. In FIG. 6, a site 630 is relevant to a base where the key management server 200 exists. A site 651 is relevant to a base where the distributed management apparatus 150 of the participant 1 exists. A site 652 is relevant to a base where the distributed management apparatus 150 of the participant 2 exists. A site 653 is relevant to a base where the distributed management apparatus 150 of the participant 3 exists. A site 655 is relevant to a base where the distributed management apparatus 150 of the participant N exists.

In FIG. 6, each of sites 610 and 611 is relevant to a base where there is a relay apparatus that can pass through upon relaying a key in a delivery route in the quantum key distribution. These sites may be hereinafter referred to as sites 1, 2,...9,10, and K. In the key relay, not only the sites 610 and 611 relevant to the relay apparatuses but also a site relevant to the participant can function as the relay apparatus in the quantum key distribution.

In FIG. 6, communicable sites in the key relay are connected by a straight line. At both ends of the straight line, relevant QKD apparatuses or QKD modules are disposed. In a case where a distance from the key management server 200 to the distributed management apparatus 150 of each participant is long, the key management server 200 and the distributed management apparatus 150 of each participant are not directly connected by a straight line. In a case where the encryption key is shared between the key management server 200 and the distributed management apparatus 150 that are not directly linked by a straight line, the encryption key is transmitted from the key management server 200 to the distributed management apparatus 150 by following a path through several sites.

For example, in the QKD network illustrated in FIG. 6, the QKDN management unit 201 generates candidates for a route that can be used to distribute the quantum encryption key for each share folder, that is, for each participant. The QKDN management unit 201 generates, for example, candidates for a route between the key management server 200 and the participant 1, that is, candidates for a route in a case where the quantum encryption key is distributed from the site 630 to the site 651. The QKDN management unit 201 stores information of the generated candidates for a route in the storage unit 210 as a delivery route candidate list 211.

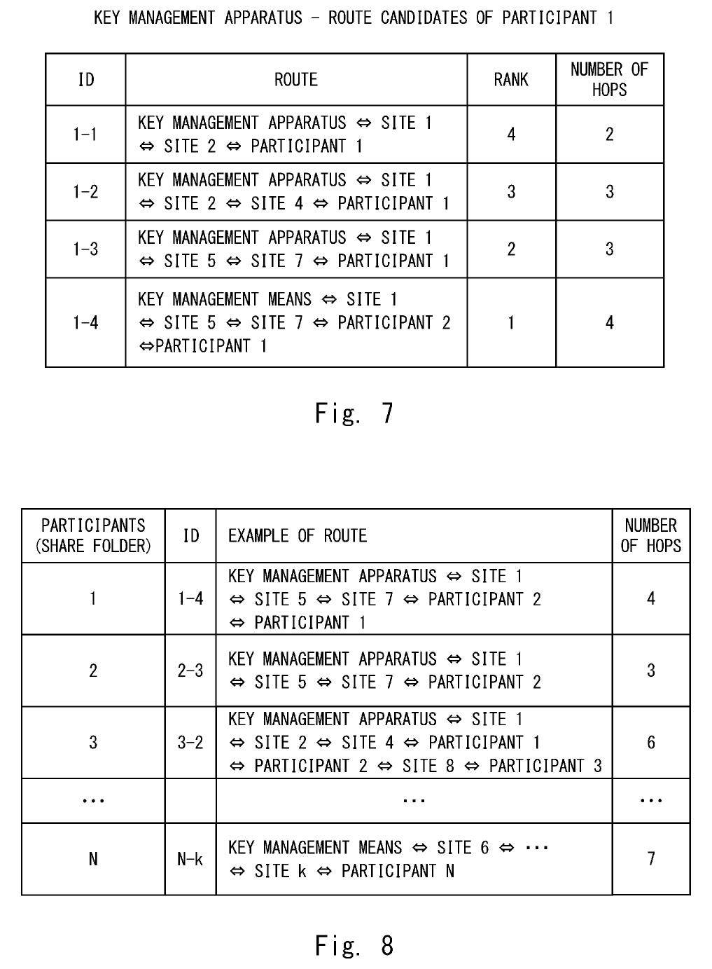

FIG. 7 is a diagram illustrating an example of the delivery route candidate list 211. In this example, the delivery route candidate list 211 includes a route ID (identifier), a route, an order, and the number of hops. The route ID is identification information for identifying a route candidate. The route indicates the order of sites via the key relay, that is, relay apparatuses. The number of hops indicates the number of relay apparatuses passing through the key relay. The order indicates the priority order of delivery route candidates determined based on a predetermined criterion. The QKDN management unit 201 generates candidates for a route that can be used to distribute the quantum encryption key for each participant, and stores information of the generated candidates for a route as the delivery route candidate list 211.

The encryption target determination unit 202 determines a share folder that performs encryption and stores a share, from a plurality of participants, that is, a plurality of share folders. In other words, the encryption target determination unit 202 determines a share folder that performs encryption among the plurality of share folders. The encryption target determination unit 202 is relevant to the determination unit 71 illustrated in FIG. 1.

Specifically, the encryption target determination unit 202 determines a predetermined number p of share folders among the N share folders as share folders being encryption targets. The predetermined number p is set to an integer satisfying N-m+1 ≤ p < N. In this case, the minimum value of the number of shares to be encrypted is N-m+1, and the number of shares that are not encrypted is at most m-1. m represents the minimum number of pieces of divided data to be restored to predetermined data as a division source. Even if the unencrypted share is acquired by the third party, the third party cannot restore the original data because the number of unencrypted shares is smaller than m.

The encryption target determination unit 202 includes an optimal route selection unit 205, a sorting unit 206, and a determination unit 207. The optimal route selection unit 205 acquires information of a transmission route in a case where key relay is performed from the delivery route candidate list 211, for each share folder. For example, the optimal route selection unit 205 acquires, as an optimal route, a route candidate having the highest rank in the delivery route candidate list 211 for each share folder. For example, the optimal route selection unit 205 selects, as the optimal route, a route that has the highest priority order and has a route ID “1-4” among the candidates for a route illustrated in FIG. 6, for the participant 1. The optimal route selection unit 205 creates a route list for each share folder, and stores the created route list in the storage unit 210 as the optimal delivery route list 212.

FIG. 8 is a diagram illustrating an example of the optimal delivery route list 212. In this example, the optimal delivery route list 212 includes a route ID, a delivery route of an encryption key, and the number of hops for each transmission section, that is, for each section between the key management server 200 and the distributed management apparatus 150. For example, the optimal route selection unit 205 extracts a route having the highest priority order from the delivery route candidate list 211 for each participant, and stores information of the extracted route as the optimal delivery route list 212.

The sorting unit 206 sorts the optimal delivery route list 212 in ascending order based on the number of hops. The determination unit 207 determines a share folder being an encryption target, based on the sorted optimal delivery route list 212. In an example embodiment, the determination unit 207 determines a predetermined number p of participants, that is, share folders from the top in the optimal delivery route list 212 sorted in ascending order by the sorting unit 206, as share folders being encryption targets.

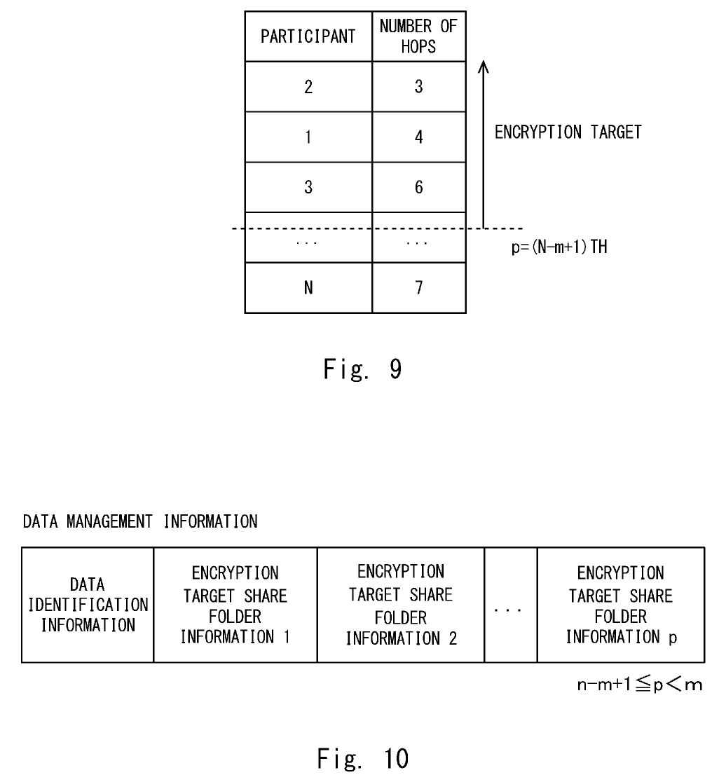

FIG. 9 is a diagram illustrating an example of determining a share folder being an encryption target. For example, the determination unit 207 determines the (N-m+1)th participant and a participant higher than the (N-m+1)th participant in the optimal delivery route list 212 in which the numbers of hops are sorted in ascending order, as participants to be encrypted, that is, share folders being encryption targets. For example, the determination unit 207 may set an encryption flag for the participant relevant to the share folder being the encryption target in the list of participants.

The key transmission unit 203 transmits the encryption key to the distributed management apparatuses 150 of the predetermined number p of participants, which are relevant to the share folders being encryption targets. The key transmission unit 203 acquires, for example, p encryption keys from a set of available encryption keys. The key transmission unit 203 transmits each of the acquired p encryption keys to the predetermined number p of distributed management apparatuses 150. The key transmission unit 203 is relevant to the key transmission unit 72 illustrated in FIG. 1.

The transaction apparatus 130 assigns data identification information to data D and notifies the key management server 200 of the assigned data identification information. The key transmission unit 203 generates data management information 213 including the data identification information, information of the predetermined number p of participants who have transmitted the encryption keys, that is, the share folders being the encryption targets, and the transmitted encryption key. The key transmission unit 203 stores the generated data management information 213 in the storage unit 210.

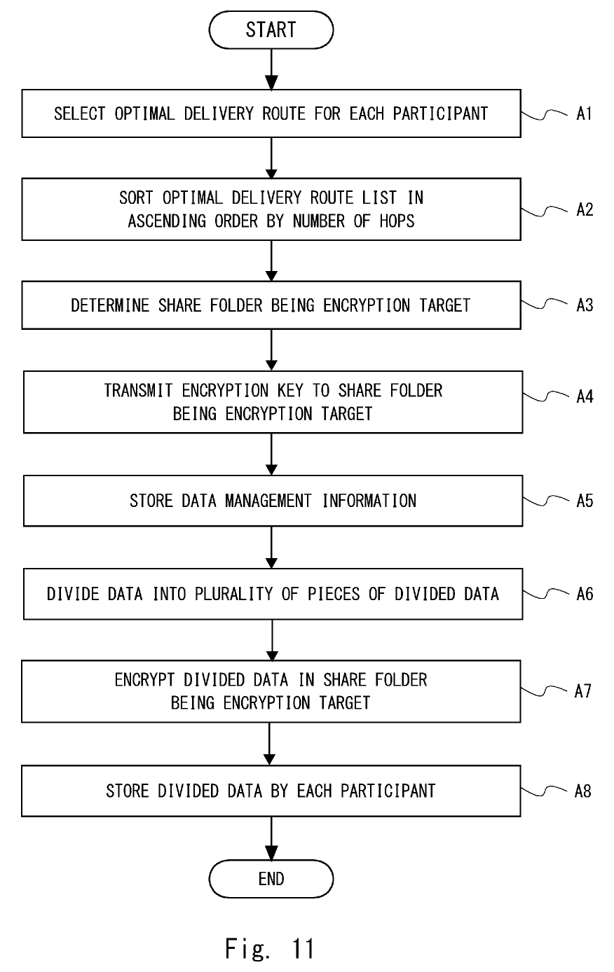

FIG. 10 is a diagram illustrating an example of the data management information 213. In this example, the data management information 213 includes data identification information and pieces of encryption target share folder information 1 to p. The data identification information indicates the ID of data D divided by the secret sharing method. The pieces of encryption target share folder information 1 to p include IDs and encryption keys of the predetermined number p of participants.

At the time of restoring data, the user apparatus 170 transmits identification information of the data to be restored to the key management server 200. In the key management server 200, the key transmission unit 203 searches the data management information 213 and acquires the pieces of encryption target share folder information 1 to p relevant to the identification information of data received from the user apparatus 170. The key transmission unit 203 transmits the encryption keys included in the pieces of encryption target share folder information 1 to p to the user apparatus 170 via the QKD platform L0 (see FIG. 4).

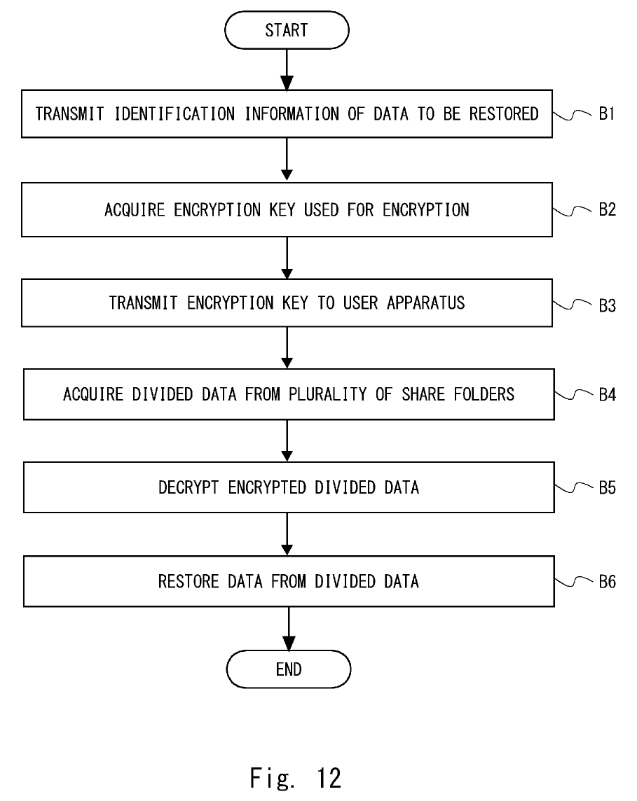

Next, an operation procedure will be described. FIG. 11 is a flowchart illustrating an operation procedure of the data storing system 100 at the time of storing data. In a case where data D is divided in the transaction apparatus 130, the optimal route selection unit 205 selects an optimal route in encryption key delivery for each of a plurality of distributed management apparatuses 150 that store the shares D1 to DN of the data D (Step A1). In Step A1, the optimal route selection unit 205 selects, for each participant, a route having the highest priority order among the candidates for a route, which are stored in the delivery route candidate list 211, as the optimal route. The optimal route selection unit 205 stores the optimal route selected for each participant in the optimal delivery route list 212.

The sorting unit 206 sorts the optimal delivery route list 212 in ascending order by the number of hops (Step A2). The determination unit 207 determines the distributed management apparatus 150 being an encryption target, that is, the share folder being an encryption target from the optimal delivery route list 212 sorted by the number of hops (Step A3). In Step A3, the determination unit 207 determines, for example, the predetermined number p of higher-level participants in the sorted optimal delivery route list 212 as share folders being encryption targets. In a case where there are a plurality of share folders having the same number of hops, the determination unit 207 may preferentially determine a participant with a smaller number in the optimal delivery route list 212 as a share folder being an encryption target. Alternatively, the determination unit 207 may compare the accumulation amount of the encryption key on the route between the share folders having the same number of hops, and preferentially determine the share folder of the route having a large accumulation amount as the share folder being the encryption target.

The key transmission unit 203 transmits an encryption key used to encrypt the divided data to the distributed management apparatus 150 relevant to the share folder being the encryption target, which is determined in Step A3 (Step A4). In Step A4, the key transmission unit 203 transmits the encryption key to p distributed management apparatuses 150 determined as share folders being encryption targets among the total N distributed management apparatuses 150. The key transmission unit 203 stores the data management information 213 including the identification information of the data D and the encryption key transmitted to the share folder being the encryption target in the storage unit 210 (Step A5). Steps A1 to A5 relevant to a key management method implemented in the key management server 200.

In the transaction apparatus 130, the division unit 131 divides the data D

into a plurality of pieces of divided data D1 to DN (Step A6). The transmission unit 132 transmits the divided data D1 to DN to the distributed management apparatuses 150-1 to 150-N relevant to the participants 1 to N. Any of Steps A1 to A5 and Step A6 may be performed first, or both may be performed simultaneously.

In the distributed management apparatus 150 relevant to the share folder being the encryption target, the encryption unit 151 encrypts the divided data by using the encryption key transmitted from the key management server 200 in Step A4 (Step A7). In the distributed management apparatus 150 that is not relevant to the share folder being the encryption target, the encryption unit 151 does not encrypt the divided data. In the distributed management apparatus 150 of each participant, the data storing unit 152 stores encrypted divided data or divided data that is not encrypted (Step A8).

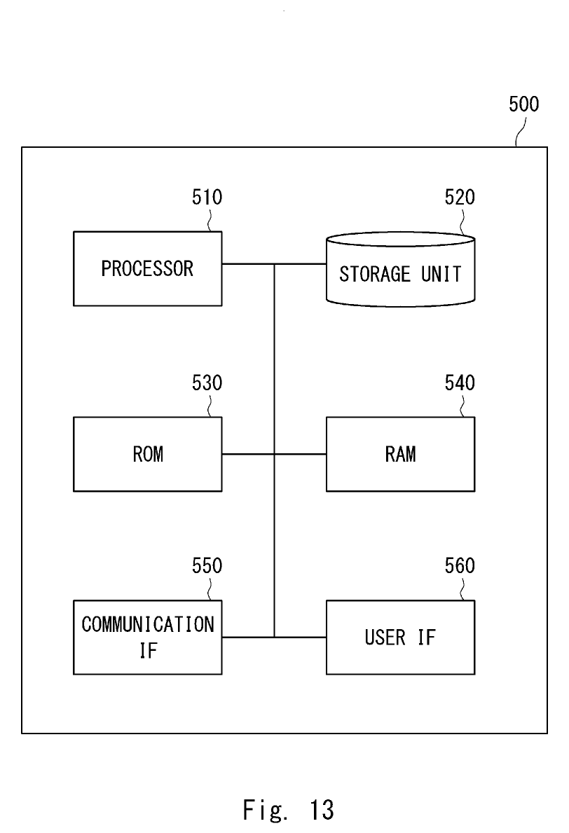

FIG. 12 is a flowchart illustrating an operation procedure of the data storing system 100 at the time of restoring data. The user apparatus 170 transmits identification information of the data to be restored to the key management server 200 (Step B1). In the key management server 200, the key transmission unit 203 acquires the information of the share folder being the encryption target and the encryption key used to encrypt the divided data from the data management information 213 (Step B2). The key transmission unit 203 transmits the encryption key used for encryption to the user apparatus 170 (Step B3).

In the user apparatus 170, the decryption unit 171 acquires the divided data stored in the data storing unit 152 of each distributed management apparatus 150 from a plurality of share folders, that is, each of the plurality of distributed management apparatuses 150 (Step B4). In Step B4, the decryption unit 171 acquires the divided data from the distributed management apparatus 150 of which the number of pieces of divided data necessary for data restoration is equal to or more than the minimum number m. The plurality of pieces of divided data acquired in Step B4 include encrypted divided data.

The decryption unit 171 decrypts the encrypted divided data by using the encryption key transmitted from the key management server 200 in Step B3 (Step B5). In Step B5, the decryption unit 171 decrypts the divided data acquired from the distributed management apparatus 150, which is the share folder being the encryption target, by using the encryption key transmitted from the key management server 200 in Step B3. The restoration unit 172 restores the original data from the divided data (Step B6). The restoration unit 172 may output the restored data for subsequent processing.

A method of the cyberattack changes and evolves every day, and it is desired to deal with the cyberattack also for data storage. For example, it is desired to consider not only one site that stores each share but also a case where a share is deprived from a plurality of sites over time, or a case where a plurality of sites are simultaneously attacked and the share is deprived as a cyber countermeasure. In particular, in a case where data is stored for a long period of time, it is considered to be important as cyber countermeasures not only to simply divide data into a plurality of pieces of divided data and dispersedly store the divided data but also to encrypt the divided data.

In an example embodiment, the determination unit 207 determines a predetermined number of share folders as share folders being encryption targets in such a way that the number of pieces of divided data that is not encrypted is less than the total number of share folders and is less than the number of divided data necessary for data restoration. In this case, it is possible to suppress the consumption of the encryption key transmitted to the participant by the quantum key distribution as compared with the case where all the share folders are set as the share folders being the encryption targets.

In an example embodiment, the determination unit 207 determines a share folder being an encryption target based on the number of hops of the delivery route in the key relay of quantum key distribution. In general, in a key relay, an encryption key is consumed by a one time pad every hop. In a case where a share folder having a small number of hops of the delivery route in the key relay is determined as a share folder being an encryption target in consideration of the number of hops of the delivery route in the key relay, it is possible to suppress the amount of encryption keys consumed by the key relay. Determining a share folder having a small number of hops as a share folder being an encryption target can be useful particularly in a case where data is stored in a remote share folder.

In a case of restoring or using the stored data, the user restoring the data collects the shares stored in the participants, that is, share folders, and restores the data. In a case where the share is encrypted in the share folder, the user needs an encryption key (common key) necessary for decrypting the encrypted share at the time of storage. Since the one time pad password is discarded at the time of encryption, it is necessary to securely share the encryption key between the participant and the user using the data for decryption. In an example embodiment, the key transmission unit 203 generates data management information 213 including an encryption key used for encryption for each stored data. In a case where the data is restored, the key transmission unit 203 acquires an encryption key used to encrypt the restored data from the data management information 213, and transmits the acquired encryption key to the user apparatus 170. In this manner, it is possible to supply, to the user apparatus 170, the encryption key necessary for decrypting the encrypted share.

In the above example embodiment, at least a part of the components of the transaction apparatus 130, the distributed management apparatus 150, the user apparatus 170, or the key management server 200 may be implemented by dedicated hardware. A part or all of each component of each apparatus or server may be achieved by a general-purpose or dedicated circuitry, a processor, or a combination of these. The circuit may be configured by a single chip or may be configured by a plurality of chips connected via a bus. Some or all of the components of each apparatus or server may be implemented by a combination of a program and the above-described circuitry or the like. The processor can include, for example, a central processing unit (CPU), a graphics processing unit (GPU), a field-programmable gate array (FPGA), a quantum processor (quantum computer control chip), or a combination of these.

FIG. 13 is a block diagram illustrating a configuration example of a computer apparatus that can be used as the transaction apparatus 130, the distributed management apparatus 150, the user apparatus 170, or the key management server 200. A computer apparatus 500 includes a processor 510, a storage unit 520, a read only memory (ROM) 530, a RAM 540, a communication interface (IF) 550, and a user interface 560.

The communication interface 550 is an interface for connecting the computer apparatus 500 to a communication network via wired communication means, wireless communication means, or the like. The user interface 560 includes, for example, a display unit such as a display. The user interface 560 includes input units such as a keyboard, a mouse, and a touch panel.

The storage unit 520 is an auxiliary storage device that can retain various types of data. The storage unit 520 is not necessarily a part of the computer apparatus 500 and may be an external storage device or a cloud storage connected to the computer apparatus 500 via a network.

The ROM 530 is a nonvolatile storage device. For example, a semiconductor storage device such as a flash memory that has a relatively compact capacity may be used for the ROM 530. A program executed by the processor 510 can be stored in the storage unit 520 or the ROM 530. The storage unit 520 or the ROM 530 stores various programs that implement the functions of the transaction apparatus 130, the distributed management apparatus 150, the user apparatus 170, or the key management server 200.

The program described above includes commands (or software codes) for causing a computer to perform one or more functions described in the example embodiments in a case where the program is read by the computer. The program may be stored in a non-transitory computer-readable medium or a tangible storage medium. As an example and not by way of limitation, the computer-readable medium or the tangible storage medium includes a RAM, a ROM, a flash memory, a solid-state drive (SSD) or any other memory technology, a compact disc (CD), a digital versatile disc (DVD), a Blu-ray (registered trademark) disc or any other optical disc storage, and a magnetic cassette, a magnetic tape, a magnetic disk storage, or any other magnetic storage device. The program may be transmitted through a transitory computer-readable medium or a communication medium. As an example and not by way of limitation, the transitory computer-readable medium or the communication medium includes an electric signal, an optical signal, an acoustic signal, or any other form of propagation signal.

The RAM 540 is a volatile storage device. As the RAM 540, various types of semiconductor memory devices such as a dynamic random access memory (DRAM) and a static random access memory (SRAM) are used. The RAM 540 can be used as an internal buffer that temporarily stores data or the like. The processor 510 loads a program stored in the storage unit 520 or the ROM 530 into the RAM 540 and executes the loaded program. The functions of the transaction apparatus 130, the distributed management apparatus 150, the user apparatus 170, or the key management server 200 can be implemented by the processor 510 executing the program. The processor 510 may include an internal buffer that can temporarily store data or the like.

In the present disclosure, each of the transaction apparatus 130, the distributed management apparatus 150, the user apparatus 170, and the key management server 200 is not necessarily configured as a single computer apparatus. The transaction apparatus 130, the distributed management apparatus 150, the user apparatus 170, or the key management server 200 may be configured by using a plurality of physically separated devices.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each example embodiment can be appropriately combined with other example embodiments.

Each of the drawings is merely an example to illustrate one or more example embodiments. Each of the drawings is not associated with only one specific example embodiment, but may be associated with one or more other example embodiments. As those skilled in the art will appreciate, various features or steps described with reference to any one of the drawings may be combined with features or steps illustrated in one or more other drawings, for example, to create an example embodiment that is not explicitly illustrated nor described. All of the features or steps illustrated in any one of the drawings for describing illustrative example embodiments are not necessarily mandatory, and some features or steps may be omitted. The order of the steps described in any of the figures may be changed as appropriate.

Some or all of the above example embodiments can also be described as the following Supplementary Notes, but are not limited to the following.

### Supplementary Note 1

A key management apparatus including:

a determination unit that determines a predetermined number of participants among a plurality of participants for storing divided data obtained by division from predetermined data by secret distribution processing, as participants for encrypting and storing the divided data by using a quantum encryption key; and

a key transmission unit that transmits an encryption key used to encrypt the divided data to each of the predetermined number of participants by quantum key distribution, in which

the determination unit determines the predetermined number of participants based on a number of hops of a key relay from the key management apparatus to each participant in the quantum key distribution, and

in a case where the predetermined number is set as p, a number of divisions of the predetermined data is set as N, and a minimum number of pieces of the divided data in a case where the predetermined data is restored from the pieces of the divided data is set as m, the predetermined number p satisfies N-m+1 ≤ p < N.

### Supplementary Note 2

The key management apparatus according to Supplementary Note 1, in which the key transmission unit stores data management information including identification information of the predetermined data, information of the predetermined number of participants determined, and the encryption key.

### Supplementary Note 3

The key management apparatus according to Supplementary Note 2, in which the key transmission unit transmits an encryption key used to decrypt the encrypted divided data to a user who restores the predetermined data, by using the data management information.

### Supplementary Note 4

The key management apparatus according to any one of Supplementary Notes 1 to 3, in which the divided data is encrypted with a one time pad by using the encryption key by the participant.

### Supplementary Note 5

The key management apparatus according to any one of Supplementary Notes 1 to 4, in which the determination unit sorts the plurality of participants in ascending order of the number of hops, and determines a predetermined number of higher-level participants having a small number of hops among the plurality of participants, as participants for encrypting and storing the divided data by using a quantum encryption key.

### Supplementary Note 6

A data storing system including:

a transaction apparatus including a division unit that divides predetermined data into a plurality of pieces of divided data by secret distribution processing, and a data transmission unit that transmits the plurality of pieces of divided data obtained by the division to a plurality of participant apparatuses;

a participant apparatus including an encryption unit that receives the divided data and encrypts the received divided data by using a quantum encryption key, and a data storing unit that stores the encrypted divided data; and

a key management apparatus, in which

the key management apparatus includes

a determination unit that determines a predetermined number of participant apparatuses among the plurality of participant apparatuses, as a participant apparatus that encrypts and stores the divided data, and

a key transmission unit that transmits, to each of the predetermined number of participant apparatuses, an encryption key used to encrypt the divided data by quantum key distribution,

the determination unit determines the predetermined number of participants based on the number of hops of key relay from the key management apparatus to each participant in the quantum key distribution, and

in a case where the predetermined number is set as p, a number of divisions of the predetermined data is set as N, and a minimum number of pieces of the divided data in a case where the predetermined data is restored from the pieces of the divided data is set as m, the predetermined number p satisfies N-m+1 ≤ p < N.

### Supplementary Note 7

The data storing system according to Supplementary Note 6, in which the division unit divides the predetermined data into the divided data in such a way that decryption of a part of the predetermined data from each piece of the divided data is not possible, and the predetermined data is able to be restored from the m pieces of divided data among the N pieces of divided data.

### Supplementary Note 8

The data storing system according to Supplementary Note 6 or 7, further including a user apparatus that acquires at least m pieces of divided data from the plurality of participant apparatuses and restores the predetermined data from the acquired at least m pieces of divided data.

### Supplementary Note 9

The data storing system according to Supplementary Note 8, in which

the key transmission unit stores data management information including identification information of the predetermined data, information of the predetermined number of participants determined, and the encryption key, and

the key transmission unit transmits an encryption key used to decrypt the

encrypted divided data to the user apparatus by using the data management information.

### Supplementary Note 10

A key management method including:

a predetermined number of participants among a plurality of participants for storing divided data obtained by division from predetermined data by secret distribution processing, as participants for encrypting and storing the divided data by using a quantum encryption key; and

transmitting an encryption key used to encrypt the divided data to each of the predetermined number of participants by quantum key distribution, in which

the determining of the predetermined number of participants includes determining the predetermined number of participants based on a number of hops of a key relay from a key management apparatus to each participant in the quantum key distribution, and

in a case where the predetermined number is set as p, a number of divisions of the predetermined data is set as N, and a minimum number of pieces of the divided data in a case where the predetermined data is restored from the pieces of the divided data is set as m, the predetermined number p satisfies N-m+1 ≤ p < N.

### Supplementary Note 11

A program for causing a computer to execute processing including:

determining a predetermined number of participants among a plurality of participants for storing divided data obtained by division from predetermined data by secret distribution processing, as participants for encrypting and storing the divided data by using a quantum encryption key; and

transmitting an encryption key used to encrypt the divided data to each of the predetermined number of participants by quantum key distribution, in which

the determining of the predetermined number of participants includes determining the predetermined number of participants based on a number of hops of a key relay from a key management apparatus to each participant in the quantum key distribution, and

in a case where the predetermined number is set as p, a number of

divisions of the predetermined data is set as N, and a minimum number of pieces of the divided data in a case where the predetermined data is restored from the pieces of the divided data is set as m, the predetermined number p satisfies N-m+1 ≤ p < N.

Some or all of the elements (for example, configurations and functions) described in Supplementary Notes 2 to 5 dependent on Supplementary Note 1 can also be dependent on Supplementary Notes 6, 10, and 11 by the same dependency relationship as Supplementary Notes 2 to 5. Some or all of the elements described in any supplementary note may be applied to various types of hardware, software, recording means for recording software, systems, and methods.

1. A key management apparatus comprising:
at least one memory storing instructions; and
at least one processor configured to execute the instructions to:
determine a predetermined number of participants among a plurality of participants for storing divided data obtained by division from predetermined data by secret distribution processing, as participants for encrypting and storing the divided data by using a quantum encryption key;
transmit an encryption key used to encrypt the divided data to each of the predetermined number of participants by quantum key distribution; and
determine the predetermined number of participants based on a number of hops of a key relay from the key management apparatus to each participant in the quantum key distribution,
wherein, in a case where the predetermined number is set as p, a number of divisions of the predetermined data is set as N, and a minimum number of pieces of the divided data in a case where the predetermined data is restored from the pieces of the divided data is set as m, the predetermined number p satisfies N-m+1 ≤ p < N.

2. The key management apparatus according to claim 1, wherein the at least one processor is configured to execute the instructions to store data management information including identification information of the predetermined data, information of the predetermined number of participants determined, and the encryption key.

3. The key management apparatus according to claim 2, wherein the at least one processor is configured to execute the instructions to transmit an encryption key to be used for decrypting the encrypted divided data to a user who restores the predetermined data by using the data management information.

4. The key management apparatus according to claim 1, wherein the divided data is encrypted with a one time pad by using the encryption key by the participant.

5. The key management apparatus according to claim 1, wherein the at least one processor is configured to execute the instructions to sort the plurality of participants in ascending order of the number of hops, and determine a predetermined number of higher-level participants having a small number of hops among the plurality of participants, as participants for encrypting and storing the divided data by using a quantum encryption key.

6. A data storing system comprising:
a transaction apparatus configured to divide predetermined data into a plurality of pieces of divided data by secret distribution processing, and transmit the plurality of pieces of divided data to a plurality of participant apparatuses;
a plurality of participant apparatuses each configured to receive the divided data, encrypt the received divided data by using a quantum encryption key, and store the encrypted divided data; and
a key management apparatus,
the key management apparatus comprising
at least one memory storing instructions; and
at least one processor configured to execute the instructions to:
determine a predetermined number of participant apparatuses among the plurality of participant apparatuses as a participant apparatus that encrypts and stores the divided data;
transmit an encryption key used to encrypt the divided data to each of the predetermined number of participant apparatuses by quantum key distribution; and
determine the predetermined number of participants based on a number of hops of a key relay from the key management apparatus to each participant in the quantum key distribution,
wherein, in a case where the predetermined number is set as p, a number of divisions of the predetermined data is set as N, and a minimum number of pieces of the divided data in a case where the predetermined data is restored from the pieces of the divided data is set as m, the predetermined number p satisfies N-m+1 ≤ p < N.

7. The data storing system according to claim 6, wherein the at least one processor is configured to execute the instructions to divide the predetermined data into pieces of the divided data in such a way that decryption of a part of the predetermined data from each piece of the divided data is not possible, and the predetermined data is able to be restored from the m pieces of divided data among the N pieces of divided data.

8. The data storing system according to claim 6, further comprising a user apparatus configured to acquire at least m pieces of divided data from the plurality of participant apparatuses, and restore the predetermined data from the acquired at least m pieces of divided data.

9. The data storing system according to claim 8, wherein the at least one processor is configured to execute the instructions to:
store data management information including identification information of the predetermined data, information of the predetermined number of participants determined, and the encryption key; and
transmit an encryption key to be used for decrypting the encrypted divided data to the user apparatus by using the data management information.

10. A key management method comprising:
determining a predetermined number of participants among a plurality of participants for storing divided data obtained by division from predetermined data by secret distribution processing, as participants for encrypting and storing the divided data by using a quantum encryption key; and
transmitting an encryption key used to encrypt the divided data to each of the predetermined number of participants by quantum key distribution, wherein
the determining of the predetermined number of participants includes determining the predetermined number of participants based on a number of hops of a key relay from a key management apparatus to each participant in the quantum key distribution, and
in a case where the predetermined number is set as p, a number of divisions of the predetermined data is set as N, and a minimum number of pieces of the divided data in a case where the predetermined data is restored from the pieces of the divided data is set as m, the predetermined number p satisfies N-m+1 ≤ p < N.
